(19) United States
(12) Patent Application Publication
(10) Pub. No.: US 2022/0318352 A1
(43) Pub. Date: Oct. 6, 2022

(54) Continuous Authentication Using Wearable Head-Mounted Devices and Gaze Tracking

(71) Applicant: TWOSENSE, INC., Brooklyn, NY (US)

(72) Inventors: Dawud Gordon, Brooklyn, NY (US); John Tanios, Brooklyn, NY (US)

(21) Appl. No.: 17/597,569

(22) PCT Filed: Jun. 23, 2020
(86) PCT No.: PCT/US2020/039210

§ 371 Date: Jan. 11, 2022

Related U.S. Application Data
(60) Provisional application No. 62/867,228, filed on Jun. 26, 2019.

(51) Int. Cl. G06F 21/32; G06F 3/01

(52) U.S. Cl. CPC G06F 21/32; G06F 3/013

(57) ABSTRACT

Traditional authentication makes the user do work for a point-in-time solution. These methods have the drawback of providing a poor user experience during the process of authentication. They are also insecure, even if perfectly accurate, because they can only be used rarely due to the level of effort required. This invention solves the problem by implementing continuous authentication on a wearable device and breaking the intention-detection problem down to a deterministic, rule-based problem. It leverages continuous authentication, such as behavioral authentication, or retina scanning, with gaze tracking, to identify a device and screen the user is interacting with, or intending to interact with, and provide authentication into that device.

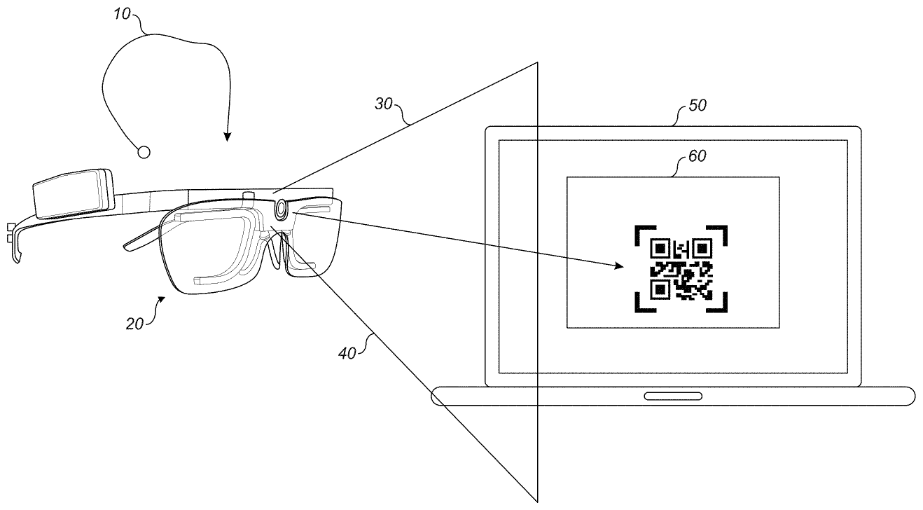

### RELATED APPLICATION

This application claims the benefit of the following U.S. Provisional Patent Application, which is incorporated by reference in its entirety:

1) Ser. No. 62/867,228, filed on Jun. 26, 2019.

### BACKGROUND

Traditional authentication makes the user do work for a point-in-time solution. These methods have the drawback of providing a poor user experience during the process of authentication. They are also insecure, even if perfectly accurate, because they can only be used rarely due to the level of effort required. Further, the system encounters the challenge of knowing if the user wants to log in, even if it is certain the user is the authorized user. To put it differently, the system has difficulty judging the intention of the user to initiate, or continue, a session.

Continuous, invisible authentication solutions solve these issues because they can be always on with little to no work. Specifically, this invention solves the problem by implementing continuous authentication on a wearable device and breaking the intention-detection problem down to a deterministic, rule-based problem. It leverages continuous authentication, such as behavioral authentication, or retina scanning, with gaze tracking, to identify a device and screen the user is interacting with, or intending to interact with, and provide authentication into that device. It leverages the aspect of human behavior that people automatically look at what they intend to interact with.

### SUMMARY

Other inventions use authentication on the device containing the account and application, such as Touch ID, Windows Hello facial recognition, etc. to biometrically authenticate the user. These do not transfer across devices and systems, are not continuous, and are often insecure and/or require some form of manual authentication or demonstration of intent to initiate the authentication transaction. Other inventions also use cross-device behavioral authentication and proximity to estimate intention, however, these may still occasionally misinterpret intent as they are not as good as gaze. These inventions are less secure, less effective, and can be less accurate. They are either invisible and poor at estimating intention, or manual, causing friction, and therefore cannot be used continuously.

This invention uses continuous authentication combined with gaze tracking and image recognition for continuous authentication and intent measurement (instead of estimation).

### BRIEF DESCRIPTION OF THE DRAWINGS

The accompanying FIGURE together with the detailed description below, are incorporated in and form part of the specification, serve to further illustrate embodiments of concepts that include the claimed invention and explain various principles and advantages of those embodiments.

The sole FIGURE is a schematic of components that work together as an embodiment of the present invention.

Skilled artisans will appreciate that elements in the FIGURE is illustrated for simplicity and clarity and have not necessarily been drawn to scale. For example, the dimensions of some of the elements in the FIGURES may be exaggerated relative to other elements to help to improve understanding of embodiments of the present invention.

The apparatus and method components have been represented where appropriate by conventional symbols in the drawing, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Wearable smart glasses contain programmable memory, energy storage, processing capability, and networking capability, sensors, and cameras. Eye-facing cameras capture real-time video of the user's eyes. Using this video, they can match the user's retina to a retina scan on profile for this user using visible light, infrared, or other forms of retina matching. They also measure the angle of the eye from straight-ahead for each eye, and by calculating the angle difference can estimate the direction and focal distance of the user's gaze. Forward facing cameras capture the user's field of view, and detect beacons, icons, devices, screens using computer vision techniques.

When a user wishes to log in, looking at the device they would want to log into, the device is identified, the identity of the user is already verified and can simply be checked, resulting in the device unlocking. At the same time, if interaction with the application is detected and the device or application is no longer the focus of attention of the user, they may be logged out. Components can be connected to each other using data connectivity over Wi-Fi, Internet Protocol (IP), Bluetooth Low Energy (BTLE), or other form of connectivity, being in each other's field of view, or both being connected to the same cloud resource of blockchain resource.

Shown in the FIGURE is a multicomponent system as an embodiment of the present invention.

Component 1 is a wearable glasses smart device 20 with cameras looking at the wearer's eyes, and cameras covering their field of vision

Component 2 is a device 50 with an app 60 on it that requires secure authentication.

The steps of operation may include the following

Step 1: Obtain invisible/continuous authentication 10 on the device 20 so it is known that the user is authenticated;

Step 2: Identify the device 50 with the app 60 interface in their field of vision 30 view (using computer vision);
Step 3: Estimate the user's gaze and identify that the user is looking at the interface;
Step 4: Exchange identifiers and/or a security key 40 encoded in some aspect of the device and its visual identifiers; and
Step 5: Grant secure access.

The wearable glasses device is worn by the user, either for this purpose or for other purposes. The device with the application is located in the vicinity of the user with smart glasses. Both the application and the glasses are connected via the internet. Both have a notion of identity that is related to each other, e.g. are connected to the same identity provider or shared in a Peer to Peer (P2P) fashion.

If step 1, 2, or 3 fails, then the user is not authenticated and require some other form of authentication. Alternatively, the user is logged out. To improve the user experience, the system may provide a timeout where either continuous authentication fails, or the user is not looking at the device before the user is logged out.

The wearable device may contain the following:
Front facing camera for the field of vision;
Eye-facing cameras; and
Inertial measurement unit.

For example the Tobii Pro—https://www.tobiipro.com/product-listing/tobii-pro-glasses-2/ may be the basis of such a device.

Gaze-tracking software may be implemented that does the following:
Continuously authenticates the user with a combination of retina authentication;
Using the eye-facing cameras and behavior-based authentication using the IMU;
Estimates the current gaze vector of the user;
Identify the authentication-seeking application or device in the field of vision; and
Detects and identifies authentication-requiring devices and applications in the field of vision of the users.

The detection may use QR codes, infrared beacons or form steganography for this purpose. This stenography should contain a time-based one-time password to protect against a man-in-the-middle attack. This stenography should contain a public key or signed data object that enables secure data exchange, as well as validation that the identifier is authentic.

In a process running on device, if authentication is needed, the authentication status may be combined with the field of view vector and overlay the gaze vector to determine if the authorized user is currently looking at the device or application on device requiring authentication. If so, the system will authenticate. If not, the system will prompt the user to focus their attention or authenticate in another manner.

If need be, the authenticated session end if the authentication state of gaze-focus of the user changes. For example, if a user removes a device, or another user puts on the device, the continuous authentication indicator would signal this and the session could be terminated, locking the application or application device and requesting another form of authentication.

Different continuous authentication types include:
Retina-based authentication;
Heart Rate authentication (ballistocardiography, EKG);
Brain scan (EEG, FMRI);
Behavioral motion;
Gaze-based;
Blink based;
Facial recognition; and
A combination of all of the above.

The gaze tracking component may be replaced by other computer-vision-based techniques, including:

1. Instead of gaze tracking, the system may use the forward-facing camera, or remote camera, to track the body of the authorized user to infer which device the user is interacting with. For example, a blind user could be behaviorally authenticated, and pass that authentication to a Fitbit by touching the Fitbit while responding to an audio cue prompting for authentication.

2. Instead of tracking the user's gaze, the system could recognize and track the user limbs and gestures, including the gesture of pointing at a device. A user could authenticate into a device using a wearable by pointing at it.

Authentication can be completed into many systems seeking authentication:
A device's operating system, e.g. Windows or iPad logon;
Device's input device, e.g. a keyboard;
Application; and
Device without a screen (Fitbit).

P2P authentication/identity instead of centralized IDP may occur as follows:
The device (wearable and application device) may conduct authentication in a P2P fashion;
Devices may sync identity and authentication requests with a 3rd party identity provider (IDP); and
The wearable device may serve as a biometric authenticator for the application device.

These processes may be done remotely or on the device. For example:
The application may be remote, on device, or the device itself;
Video processing, both of the view and of the eyes for gaze and authentication, may be on either the device or remotely; and
Behavioral authentication may be local or remote;

Devices may identify themselves to the glasses by:
Showing tags;
Flickering/changing the framerate;
Infrared LEDs;
A physical tag;
Visual QR codes;
Using computer vision to identify the visuals of the device itself by its characteristics; and
Physical drawings or tags on devices themselves, without the help of any digital media.

Synchronization of the vector of the motion of the device from video may occur with the measured acceleration of the device to identify it. For example, if the app requiring authentication is on a smartwatch, and a watch is identified on camera, the motion of the watch can be estimated from the video, and matched with the estimated acceleration of that watch from the video and measured accelerometer readings from the watch. Sensor data analysis is used to determine that they are worn on the same body.

Devices could use audio pings, even in inaudible spectrums, and then multiple microphones to estimate the field of vision (hearing) vector. These pings could still encode keys, e.g. using on-off key encoding.

The wearable for doing continuous authentication may be disconnected from gaze and field of vision estimators but connected using Inertial Measurement Unit (IMU) measurements from both devices to identify that they are on the same body, i.e. being worn by the same user. For example:
A laptop with a camera that does body/pose estimation and gaze, as well as a Fitbit;
Laptop estimates the body in front of it and that it is looking at the laptop displaying login to a secure app;
While tracking micro-motions of the body, it estimates acceleration at the Fitbit's location; and
Matches that with actual Fitbit IMU measurements (which are used for continuous authentication, or Fitbit has some other authenticator like a thumbprint), to grant access to a secure application.

Any IMU-based component may be replaced by a camera with a physics engine that estimates acceleration based on video streams and model parameters. This can be a remote camera that observes the motion of the device and translates to accelerometer values, or a camera on the device that observes image motion and translates to accelerometer values.

Gaze recognition and computer vision may be used to identify the application a user is interacting with, one of many on a device, for authentication.

Authentication may be a combination of one form (i.e. retina scan) and IMU, where the IMU inputs are used to estimate if the device is still on-body, and still on the same body. This does not need to continuously authenticate but only estimate that the previous authentication is still valid. This would allow scheduled authentication events with lightweight on-body estimation (e.g. variance of IMU L1 norm over 2 second window>0.001) in between.

The system could use manual authentication that is not continuous, e.g. a thumbprint reader, at the moment the user puts the device on, and use cameras and sensors to simply detect continuously that the device has not been set down, or transferred to another user. Instead of continuous authentication, the system would work the same way if it ensured the user was authenticated at mounting, and then had not changed, rather than continuously authenticating the user. The result would be the same.

This invention could also be used to establish a “trusted device” relationship between the user's wearable and the application device, another device, or two other devices.

Gaze recognition could be implemented on the device serving the application, rather than on the wearable.

Continuous authentication could be implemented on the device serving the application, rather than on the wearable, e.g. behavior-based, face or retina based, audio based, or some other form of authentication. This could in instead of, or in addition to, wearable authentication.

The device serving the application could detect the wearable in its field of vision, rather than have the wearable detect the device.

Instead of recognizing the device the user wants to log into using the forward-facing camera, the device could recognize the user's wearable in the environment using its own cameras. The outward-facing positional tagging on the glasses operates such that a remote camera could be used, allowing the gaze estimation locally on the glasses to be put in the context of the device and application from environmental camera feeds. An example of this is a series of 3 infrared LEDs on the glasses in a triangle formation. A camera on a laptop would detect the triangle and compute relative position and angle. Gaze vector from the glasses could then be translated to the interface.

Authentication could be conducted in a completely P2P fashion where the root of identity would be embedded in the wearable or application device and shared as a certificate or token that grants access or description to the other device.

The root of identity could also be keys to a blockchain account, certificate or smart contract.

To use the invention, place a device equipped with the invention on a user's head and begin interacting with the user's device of choice. The device will log the user in without prompting for input. If an app is opened (for example, a banking app) that app will log in automatically as well. If anyone else tries to use the device or use the app while the user is otherwise engaged, the system will shut down immediately.

The invention can be used by individuals with disabilities who would otherwise have difficulty authenticating.

The system could track failed attempts and over-the-shoulder attacks.

The system could be used to improve productivity tracking and improvements.

The system could be used for cross-device authentication.

This invention could provide seamless cross-device authentication experiences.

This invention could also be used to seamlessly pair two other devices together, e.g. by authenticating into each independently and then authenticating them with each other if they are in the same field of vision. Now the devices may be securely paired.

This invention also presents a new method of initiating secure communication that is both ID-authenticated and cryptographically secured. ID-authenticating secure key exchange may occur between the application and/or application device and the user's wearable, as well as internet address exchange, since the visual identifier cue may contain an encoded public key.

This setup may prove valuable for impaired users. Specifically, it may be used by users with motor impairments, or blind users (using body tracking and touch to replace gaze tracking or audio-based device authentication).

This invention can also create a way to authenticate users and their personal devices to public interfaces and displays. For example, several users in a train station could see the same public display with a QR code that presents the displays public key and Time-based One-time Password (TOTP). This combines authentication and key exchange for secure authenticated communication that gives the user a fusion of their private personal information and public or aggregate information.

For a camera-based user identification system (with or without authentication), this invention could replace the need for visual user identification as well. This occurs where an environmental camera system identifies wearables in its field of view, and performs ID and/or key exchange with the devices after uniquely identifying the device using tagging, motion analysis, etc. and the continuous authentication methods provided by the device or camera (now obviating identification).

The preceding description and illustrations of the disclosed embodiments is provided in order to enable a person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein. While various aspects and embodiments have been disclosed, other aspects and embodiments are possible. The various aspects and embodiments disclosed are for purposes of illustration and are not intended to be limiting.

The foregoing descriptions, formulations, diagrams, and figures are provided merely as illustrative examples, and they are not intended to require or imply that the steps of the various embodiments must be performed in the order presented or that the components of the invention be arranged in the same manner as presented. The steps in the foregoing descriptions and illustrations may be performed in any order, and components of the invention may be arranged in other ways. Words such as “then,” “next,” etc., are not intended to limit the order of the steps or the arrangement of components; these words are used merely to guide the reader through the description of the invention. Although descriptions and illustrations may describe the operations as a sequential process, one or more of the operations can be performed in parallel or concurrently, or one or more components may be arranged in parallel or sequentially. In addition, the order of the operations may be rearranged.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. (canceled)

2. A system, comprising:
a wearable object comprising an authenticator, a gaze tracker, and an image recognizer;
wherein the authenticator uses continuous authentication to authenticate an identity of a user wearing the wearable object;
wherein the gaze tracker tracks a direction of the user's gaze;
wherein the image recognizer determines an identity of a device within the direction of the user's gaze;
wherein, the authenticator and the device are connected to an identity provider; and
wherein, after exchanging identifiers with the device via the identity provider, the authenticator unlocks access to the device during a first time period when the device is within the direction of the user's gaze.

3. The system as in claim 2, wherein the authenticator locks access to the device during a second time period when the device is not within the direction of the user's gaze.

4. The system as in claim 2, wherein the image recognizer measures an angle of the user's eye from straight-ahead for each eye, and calculates angle differences to estimate a direction and focal distance of the user's gaze.

5. The system as in claim 2, wherein the wearable object includes at least one of: (1) a front facing camera; (2) an eye-facing camera; and (3) an inertial measurement unit.

6. The system as in claim 2, wherein the identity provider uses form stenography including a time-based one-time password.

7. The system as in claim 2, wherein the continuous authentication includes at least one of: (1) retina-based authentication; (2) heart rate-based authentication; (3) behavioral motion-based authentication; (4) gazed-based authentication; (5) blink-based authentication; and (6) facial recognition-based authentication.

8. The system as in claim 2, wherein the identifier for the device includes at least one of: (1) physical tags; (2) changing framerate; (3) infrared LEDs; and (4) QR codes.

9. The system as in claim 2, wherein the identity provider conducts authentication in a P2P fashion.

10. A system, comprising:
a wearable object comprising an authenticator, a movement tracker, and an image recognizer;
wherein the authenticator uses continuous authentication to authenticate an identity of a user wearing the wearable object;
wherein the movement tracker tracks a user's movement;
wherein the image recognizer determines an identity of a device within the direction of the user's movement;
wherein, the authenticator and the device are connected to an identity provider; and
wherein, after exchanging identifiers with the device via the identity provider, the authenticator unlocks access to the device during a first time period.

11. The system as in claim 10, wherein the authenticator uses synchronization of motion of the device observed by the image recognizer.

12. The system as in claim 10, wherein the device is worn by the user.

13. The system as in claim 10, wherein the user's movement includes pointing to a device.

14. The system as in claim 10, wherein the wearable object includes at least one of: (1) a front facing camera; (2) an eye-facing camera; and (3) an inertial measurement unit.

15. The system as in claim 10, wherein the identity provider uses form stenography including a time-based one-time password.

16. The system as in claim 10, wherein the continuous authentication includes at least one of: (1) retina-based authentication; (2) heart rate-based authentication; (3) behavioral motion-based authentication; (4) gazed-based authentication; (5) blink-based authentication; and (6) facial recognition-based authentication.

17. The system as in claim 10, wherein the identity provider conducts authentication in a P2P fashion.

18. The system as in claim 10, wherein the identifier for the device includes at least one of: (1) physical tags; (2) changing framerate; (3) infrared LEDs; and (4) QR codes.

19. A system, comprising:
a device comprising an authenticator and a gaze tracker;
a wearable object;
wherein the device uses continuous authentication to authenticate an identity of a user wearing the wearable object;
wherein the image recognizer determines an identity of a device within the direction of the user's gaze;
wherein the gaze tracker tracks a direction of the user's gaze;
wherein the authenticator and the device are connected to an identity provider; and
wherein, after exchanging identifiers with the device via the identity provider, the authenticator unlocks access to the device during a first time period when the device is within the direction of the user's gaze.

20. The system as in claim 19, wherein the authenticator locks access to the device during a second time period when the device is not within the direction of the user's gaze.

21. The system as in claim 19, wherein the identity provider conducts authentication in a P2P fashion.
